(19) United States
(12) Patent Application Publication
(10) Pub. No.: US 2013/0152650 A1
(43) Pub. Date: Jun. 20, 2013

(54) METHOD AND DEVICE FOR TREATMENT OF CONTINUOUS OR DISCRETE METAL PRODUCTS

(71) Applicants: Rudiger Eichler, Taby (SE); Anders Engbom, Vasteras (SE)

(72) Inventors: Rudiger Eichler, Taby (SE); Anders Engbom, Vasteras (SE)

(21) Appl. No.: 13/639,152

(22) PCT Filed: Mar. 24, 2011
(86) PCT No.: PCT/SE2011/050333

§ 371 Date: Nov. 16, 2012

(30) Foreign Application Priority Data
Apr. 6, 2010 (SE) 1050329-0

(51) Int. Cl. C21D 1/52; F27B 9/10; B21D 11/20; C21D 9/56

(52) U.S. Cl. CPC C21D 1/52; C21D 9/56; F27B 9/10; B21D 11/20
USPC 72/38; 432/10; 432/11; 432/146; 72/364

(57) ABSTRACT

A method for heating an elongated metal product includes heating at a first heating location with at least one burner the metal product, and conveying combustion products from the burner through at least one channel, isolated from the metal product, from the first heating location to at least a second heating location arranged along a conveyor path for the combustion products to impinge upon an opposite surface of the metal product when the metal product passes the second heating location. A device for heating the elongated metal product is also provided.

### BACKGROUND OF THE INVENTION

The present invention relates to a method and a device for treating metal products in the form of continuous, elongated products such as strips or rods, or alternatively discrete sheets.

DFI (Direct Flame Impingement) is a known technology in which a flame from a burner is impinged directly onto the surface of a material to be heated. DFI heating has some advantages compared to other heating techniques. For instance, it is difficult to achieve high thermal transfer during heating in a furnace chamber the atmosphere of which is heated using conventional burners, radiation tubes or electrical heating elements, especially for materials with low emissivity. Induction heating can give better thermal transfer, but is on the other hand sensitive to the geometry of the heated material.

Therefore, it is in many cases desirable to use DFI for heating various metal products. In particular, this is true for continuous, elongated products such as strips and rods, as well as discrete metal sheets, which may be transported on a conveyor path past one or several DFI burners and thereby be heated quickly and efficiently. Such devices are described among others in Swedish patent applications nos. 0502913-7 and 0702051-4.

However, there are problems in using DFI for heating of such metal products. In case they are comparatively thin, the heat conduit along the product will be limited, giving rise to temperature differences.

In the opposite case, with comparatively thick strips or sheets, overheating of the material surface is risked before the core of the material has had time to reach the desired final temperature. This is conventionally solved by using for example pulsed DFI heating, which by way of example is described in Swedish patent application no. 0600813-0. However, this is expensive in the case with a strip or sheets which are continuously being transported along a conveyor path, since several DFI burners are required, arranged one after the other.

These problems exist in particular when manufacturing sheets of certain types of high-tensile steel, for example for use in car manufacturing, whereby high demands are imposed on strength in combination with low weight, i.e. thin structures and efficient corrosion protection with good adhesivity for lacquers.

Conventional galvanization using zinc works badly in these applications, because of grain boundaries for the resulting zinc alloy resulting in problems with brittleness in the sheet metal. Rather, such sheets are often anti corrosion treated using a similar process in which the sheet is coated with a layer of aluminum, heated to annealing temperature and heat treated so that the aluminum layer is partly alloyed with the steel material. In order to achieve desired material properties, it is important that the sheet thereafter is cooled rapidly in a press-cooling step, whereby the sheet also obtains its desired shape.

Using such a process, both surface and material properties, corrosion resistance and a desired shape can be achieved efficiently. However, the heating to annealing temperature takes much time, often more than 5 minutes, and is why heating is a bottleneck for scaling up of the process. Normally, the heat treatment step takes about 1-2 minutes, which is necessary in order to achieve sufficient alloying.

It has proven difficult to shorten the heating time, because of the special material properties of the aluminum coated steel sheet. Aluminum has a very low emission factor (lower than that of zinc), which results in limited heat transfer to the material. The often complicated geometry of the present steel sheets makes induction heating problematic. Direct contact heating is also problematic, since the surface layer will melt during the heating. Today, therefore, most often furnaces heated by radiation tubes or electrical heat elements are used for the heating- and heat treatment steps.

In order to avoid hydrogen penetration, resulting in deteriorated material properties, hydrogen free atmospheres, such as nitrogen or dried air, are conventionally used. This demand, in combination with the risk of over-heating of the material surface, has hitherto made DFI heating not useful in this application.

### SUMMARY OF THE INVENTION

The present invention solves the above described problems.

Thus, the present invention relates to a method for heating a continuous elongated metal product such as strip or rod, alternatively a discrete sheet, which is transported on a conveyor path, where the heating takes place at a first heating location using at least one burner, past which the metal product is transported, where the combustion products from the burner are conveyed through at least one channel, which is caused to run, isolated from the metal product, on to at least a second heating location, which is caused to be arranged along the conveyor path, so that the combustion products from the burner are caused to impinge upon a second, opposite surface of the metal product when the metal product passes the second heating location, and is characterised in that the burner is caused to be a DFI (Direct Flame Impingement) burner the flame of which during passage is impinged directly against a first surface of the metal product, and in that the channel is caused to run from the place where the flame of the burner is arranged to impinge against the first surface.

### BRIEF DESCRIPTION OF THE DRAWINGS

In the following, the invention will be described in detail, with reference to exemplifying embodiments of the invention and to the appended drawings, of which:

FIG. 1 is a side view of a DFI device according to the present invention;

FIG. 2 is an outline diagram of a process line suitable for performing a method according to the present invention;

FIG. 3 is a side view of a first DFI step;

FIG. 4 is a side view of a second DFI step;

FIG. 5 is a top view of the second DFI step illustrated in FIG. 4; and

FIG. 6 is a top view of a third DFI step.

### DESCRIPTION OF THE INVENTION

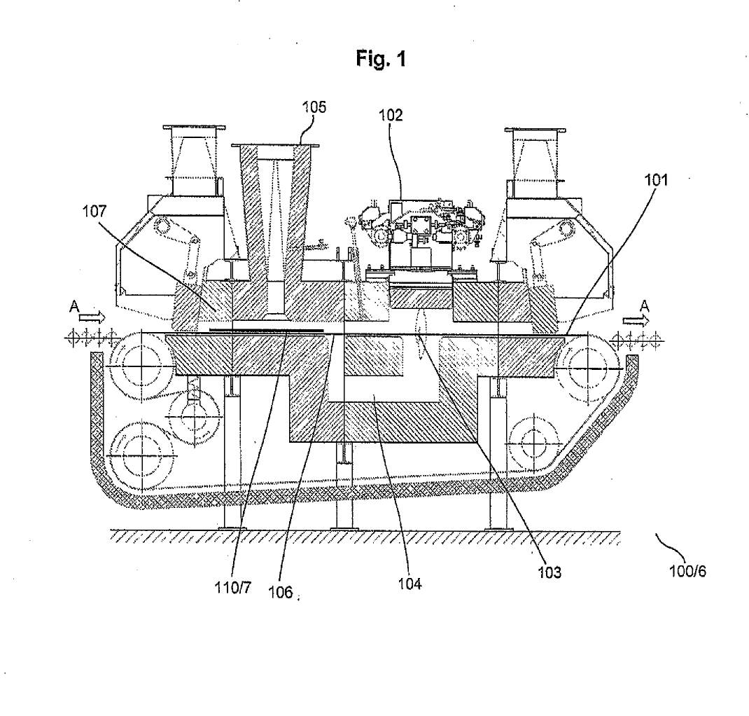

FIG. 1 shows a DFI device 100 for heating a continuous elongated metal product 110, such as a strip or a rod, alternatively a discrete metal sheet, comprising a DFI burner 102. In FIG. 1, the metal product 110 is illustrated as a discreet sheet, but it is realized that what is said herein is also applicable, when possible, to continuous metal products.

The metal product 110 is transported in the direction A, on a conveyor path 101 inside a containment 107, and is heated at a first heating location 103 by the flame from the DFI burner 102, which DFI burner 102 is arranged above the metal product 110 so that the flame impinges directly upon the upper surface of the metal product 110 at the location 103.

The combustion products from the DFI burner 102 are conveyed through a channel 104, running from the location 103 on to a second heating location 106 along, and at a different location along, the conveyor path 101, and there impinges upon the metal product 110 from its underside when the metal product 110 passes the second heating location 106. The combustion products from the DFI burner 102 continue out via one or several chimneys 105.

The channel 104 is arranged to run so that the combustion products from the flame are isolated from the metal product 110. This is to be interpreted so that the channel runs from the first heating location 103 on to the second 106, and that the combustion products in at least one location there between do not come into direct contact with the metal product 110.

The DFI burner 102 and the channel 104 can also be arranged in comparison to each other and to the conveyor path 101 so that the flame impinges upon the surface of the metal product 110 from another surface, such as from its underside or from a side surface, as long as the combustion products are led through the channel 104 and impinge upon the surface of the opposite side of the metal product 110 at the second heating location 106.

The embodiment illustrated in FIG. 1 is preferred, since the positioning of the DFI burner 102 above the conveyor path avoids problems with oxide scale falling down from the heated material, and such.

By allowing a DFI flame to heat the metal product 110 at the first heating location 103, and at the same time allowing the hot combustion products from the DFI burner 102 heat the metal product 110 at the second heating location 106, a type of pulsed heating is achieved without having to install DFI burners at both heating locations 103, 106. This will provide for the use of DFI heating for thicker metal products 110, especially since the heating at both heating locations 103, 106 takes place from opposite sides of the product 110. Moreover, an improved heating efficiency is achieved, since the heat from the DFI burner 102 can be transferred to the metal product 110 in two steps. This will in turn decrease the risk of overheating, since the power of the DFI burner 102 can be lower than in a corresponding device with only one heating location and without the channel 104.

It is preferred that the second heating location 106 is arranged upstream of the first heating location 103 along the direction A of movement of the conveyor path 101, which is illustrated in FIG. 1. Such an arrangement increases the heating efficiency, since the temperature difference between the combustion products and the metal product 110 in this case becomes larger at the second heating location 106.

A simple and therefore preferred method of achieving the arrangement illustrated in FIG. 1 is that the conveyor path 101 is perforated, and that the channel 104 connects to the conveyor path 101 so that the flame can pass through the conveyor path 101 as such and on into the channel 104, and so that the hot combustion products can impinge onto the metal material 110 from its underside, through the conveyor path 101 at the second heating location 106. Preferred designs of the conveyor path 101 to achieve this is that it comprises a transport surface made from mesh belt (metal conveyor belt) or from the upper surfaces of a series of walking beams, which may be water cooled.

Depending on how long the metal products are that are heated by the device 100, and depending on the length of the channel 104, one and the same metal product 110 will be heated at the same time or at different points in time at the first 103 and the second 106 heating locations. Depending on the detailed design of the first heating location 103, either a metal product 110 will be able to block the stream of combustion products through the channel 104 as the flame impinges upon the metal product 110, alternatively the combustion products may continue down through the channel 104 via the side or sides of the metal product 110. The latter is preferred. In practice, this may for instance be accomplished by the containment 107 being substantially wider than the metal product 110 at the first heating location 103, and by there being a free path for the combustion products down into the channel 104 on the sides of the metal product 110, through or to the side of the conveyor path 101. Another alternative features separate channels (not shown) on the side of the conveyor path 101, conveying the combustion products from the first heating location 103 and on into the channel 104. In certain applications, combustion products being led past the metal product 110 via its sides can also be led into one or several other channels than the channel 104.

It is for strength reasons preferred that several parallel channels are used rather than the single channel 104 shown in FIG. 1.

According to a preferred embodiment, a part of the combustion products is additionally led from the DFI burner 102 along the conveyor path 101, in contact with the metal product 110, from the first heating location 103 and on to the second heating location 106, where they join the combustion products led through the channel 104.

In order to increase the heat transfer to the material, it is preferred that the DFI burner is driven with an oxidant comprised of at least 85 percentages by weight oxygen.

It is preferred to use a ramp with DFI burners, which is conventional as such, instead of a single DFI burner 102. Such a ramp is preferably arranged having an angle, preferably 90°, as compared to the direction A of transportation.

Such a ramp comprising several adjacent DFI burners is known from Swedish patent application no. 0502913-7, and with a single elongated, connected DFI flame from Swedish patent application no. 0702051-4. The use of these ramps instead of one single or occasional DFI burners in general gives rise to an elongated, preferably continuous DFI flame towards the surface of the metal product 110, and thereby makes possible simultaneous, efficient and even heat transfer to the surface across its entire width.

What is described herein in connection to FIG. 1 is also valid, whenever applicable, in a corresponding way, for a DFI burner ramp, as well as for one or several individual DFI burners.

In order to additionally decrease the risk of overheating of the surface of the metal product 110, it is preferred that the velocity of the conveyor path 101 past the DFI burner 102 is sufficiently high to avoid surface damage, especially that the velocity of the conveyor path 101 is higher than the velocity of connecting conveyor paths upstream and/or downstream of the path 101.

Hence, using a DFI device of the above described type, continuous, elongated metal products, as well as discrete metal sheets can be heated rapidly and efficiently, even in case the thickness of the products is up to about 5 cm.

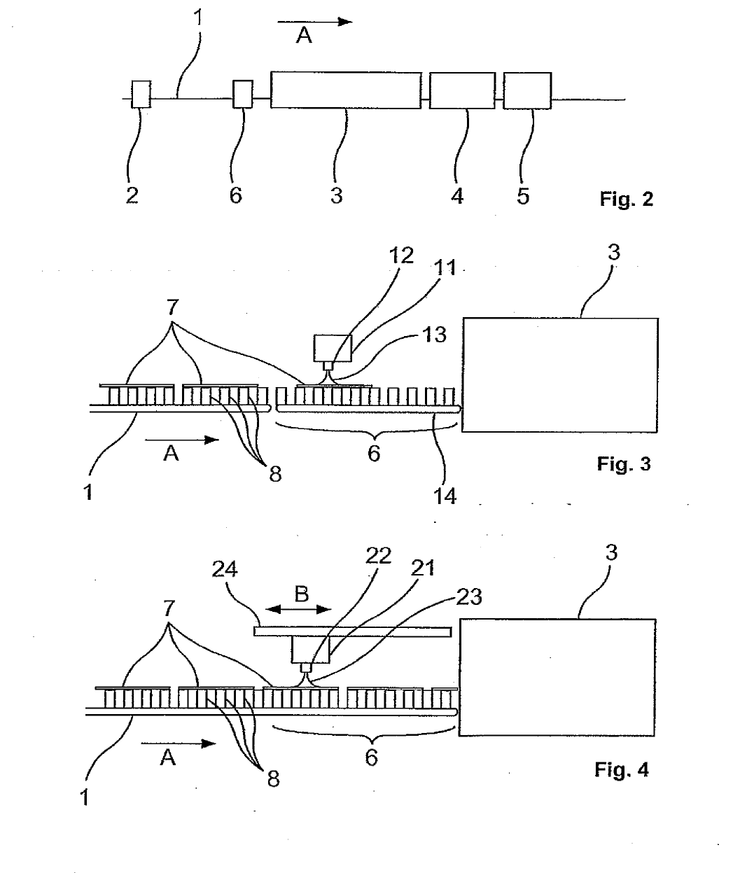

FIG. 2 illustrates a process line for treating aluminum coated steel sheets according to a method of the present invention. A conveyor path 1 transports discrete steel sheets (see FIGS. 3-6) in the direction A of transportation from a preparatory step 2, in which a surface of each respective sheet is coated with a layer of aluminum. Step 2 is carried out before the method according to the present invention is started, and can be performed in the same plant as the heating of the sheet or someplace else. In connection to the preparatory step 2, or before, the sheet can also be punched or otherwise be formed to a desired contour. According to the invention, the thickness of the steel sheet in this application is less than or equal to 5 mm, more preferably less than or equal to 4 mm, most preferably less than or equal to 3 mm. The thickness is preferably at least 0.1 mm, more preferably at least 0.5 mm, most preferably at least mm. Each sheet is preferably at most 2 meters in length.

After the preparatory step 2, the aluminum coating is as a rule in solid phase. The sheets can also be allowed to assume room temperature.

Thereafter, the sheets are further conveyed to a heating step, in which they are heated, in a first furnace 3, to a temperature which is sufficiently high both for the aluminum to alloy with the steel material and for the steel material to be annealed so that it becomes soft. The temperature is preferably at least an austenitizing temperature for the steel quality used, preferably at least 900° C., most preferably 900-950° C. A high alloying temperature is preferred, since this speeds up the process.

After the heating, the sheets are subjected to an alloying step, in which they are held, in a second furnace 4, at the achieved temperature during sufficient time for alloying between the steel material and the aluminum coating to take place, and so that desired surface properties, in terms of corrosion resistance, ability to be lacquered, esthetics, etc., are fulfilled. Normally, about 2 minutes holding time is required in the second furnace 4.

The heating in the first 3 and second 4 furnaces can take place in a way which is conventional as such. It is customary to use a hydrogen free atmosphere, to avoid hydrogen penetration into the material of the sheet, leading to hydrogen embrittlement. The atmosphere is preferably dry or inert, such as a nitrogen atmosphere or dried air. In order to maintain the atmosphere, radiation tubes or electrical heating elements are advantageously used for heating of the furnaces 3, 4.

According to a preferred embodiment, the furnace 3 and the furnace 4 is one and the same furnace, with a common, elongated furnace chamber through which the sheets are transported. It is preferred that the sheets in this case are conveyed by one and the same conveyor path 1, preferably in the form of rolls or walking beams, through furnaces 3, 4 at an essentially constant velocity. Preferably, furnaces 3, 4 have a total length of 15-60 meters, more preferably 20-40 meters.

Finally, each sheet is submitted to a pressing step 5, in which the sheet is pressed during rapid cooling to a desired shape. During the press-cooling, which advantageously is water cooled, rapid cooling of the material is obtained, which achieves desired good material properties.

In order to achieve these properties, it is necessary that the heating, alloying and press-cooling takes place with no intermediate change-over times and/or cooling. Therefore, it is preferred to perform the method according to this embodiment on discrete details rather than on continuous, elongated products such as strips of sheet steel. Namely, in order to be able to press-cool in the last step 5 it is necessary that the heated and alloyed sheets have a desired final contour already before the pressing, in order to avoid unnecessary material waste and heating of parts of the sheet that are not used.

According to the invention, a DFI preheating step 6 of the type described above in connection to FIG. 1 is arranged after the preparatory step 2 but before the sheets enter the first furnace 3. The heat transfer between a DFI burner and the aluminum surface of the steel sheets is efficient, but not as sensitive to the often complicated geometrical shapes of the sheets as is induction heating. Direct contact heating is not suitable, since the surface coating must be heated to above its melting point. On the other hand, using DFI heating it is possible to rapidly achieve a relatively high sheet temperature, whereby the heating time in the first furnace 3 can be shortened substantially, in certain cases the heating step 3 can even be omitted.

According to a preferred embodiment, the sheets in the DFI preheating step 6 are heated to the final desired alloying temperature. However, in some cases it may be difficult to achieve this without risking overheating of the sheets, which is not desirable. Therefore, it is preferred to instead heat the sheets in the DFI preheating step 6 to the alloying temperature minus 400° C., more preferably the alloying temperature minus 200° C., most preferably the alloying temperature minus 100° C., and to thereafter heat additionally, to final alloying temperature, in the first furnace 3.

Since the alloying process is sensitive to hydrogen penetration, it may be and has been feared that the hydrogen rich environment in a DFI flame runs the risk of damaging the final properties of the sheet. However, the present inventors have surprisingly discovered that for sheets having the above described thin thicknesses, the dwell time in the DFI preheating step 6 can be made so short sa that negative consequences resulting from hydrogen penetration become so small that they essentially do not affect the end result, especially when the preheating is carried out to a final temperature which is lower than the melting temperature of the surface layer.

By using a DFI device 100 as described above, the heating to desired alloying temperature can take place considerably more rapidly than what has been possible before. As a result, the total process time can be decreased without additional space requirements, since the transport velocity through furnaces 3, 4 is raised. This way, also the velocity for each sheet through the DFI device 6 will be high, in many cases sufficiently high in order to avoid surface damage to the sheets with no need for the transport velocity past the DFI burner or burners to be elevated as compared to that for other parts of the conveyor path 1.

A conventional process line for a continuous strip which is to be zincified can move at velocities in the order of 100 meters per minute. The velocity of the discrete, aluminum coated sheets 7 in the herein described process line may, however, in some applications be considerably lower, depending foremost on the required alloying time. Therefore, there is in such embodiments often a risk of overheating in the DFI step 6, despite the pulsed heating being the result of the use of the above described DFI device.

In order to avoid such overheating, it is in such applications, especially in case the transport velocity through furnaces 3, 4 is lower than about 10 meters per minute, more preferably lower than about 5 meters per minute, preferred that the flame of the DFI burner or the flames of the DFI burners in the DFI preheating step 6 are caused to sweep across the surface of the sheet steel at a relative velocity which is higher than a certain path velocity. The expression “relative velocity” herein refers to a velocity difference between the flame of the DFI burner and the material surface of the sheet metal. It is preferred that the relative velocity between the sheet and the DFI burner is measured in the direction A of transportation and/or in a direction which is opposite thereto.

The said path velocity is selected to be representative for the average door-to-door velocity of the steel sheet through the process line from the DFI preheating step 6 on to the pressing step 5. The representative path velocity is, according to a preferred embodiment, at least equal to the total average transport velocity for the metal sheet through the first 3 and second 4 furnace. According to a preferred embodiment, the representative path velocity is additionally at least equal to the average transport velocity of the sheet or sheets immediately prior to the DFI preheating step 6, or, in case no variation of velocity occurs for the sheets just before the DFI preheating step, the instantaneous transport velocity at the same location. In other words, the DFI flame is swept across the material surface at a velocity which is greater than the velocity of the metal sheets on the conveyor path 1 before the DFI preheating step 6.

According to a preferred embodiment, the transport velocity of the metal sheets through the whole process from the DFI preheating step 6 up to and including the second furnace 4 is essentially constant.

FIGS. 3-6 illustrate various embodiments of DFI preheating steps 6 that are preferred for use for preheating aluminum coated steel sheets as described above. The DFI preheating step 6 in each of respective FIGS. 3-6 thus corresponds to the DFI device 100 illustrated in FIG. 1. In order to increase clarity in FIGS. 3-6, however, the containment 107, channel 104 and chimney 105, among other things, are not shown.

In order to achieve a relative velocity which is greater than the representative transport velocity of the sheet, the conveyor path 1 is, according to a preferred embodiment illustrated in FIG. 3, arranged so that the transport velocity for a sheet 7 in the DFI preheating step 6 is caused to be greater than the above path velocity as the sheet 7 is conveyed past a stationary burner device or burner ramp 11 comprising one or several DFI burners 12, in turn arranged to allow a flame 13 to directly impinge upon the surface of the sheet 7.

The velocity increase can for example be accomplished by letting the sheet switch to another conveyor path 14, corresponding to the path 101 in FIG. 1, with greater velocity than the conveyor path 1, whereby the sheet 7 is conveyed past the stationary burner 12 at a greater velocity than the transport velocity along the path 1 arranged before the path 14. In other words, the distance between two consecutive sheets 7 on the path 14 will be greater than the corresponding distance on the path 1. The corresponding may be true regarding the transport velocity and the distance on a subsequent conveyor path in the furnace 3. This elevated velocity of the conveyor path 14 hence corresponds to that described above for the path 101 in connection to FIG. 1.

According to an alternative or complementary, preferred embodiment, illustrated in FIG. 4, the elevated relative velocity is achieved by a DFI burner device or ramp 21, comprising one or several burners 22 with respective flames 23, being led in the DFI preheating step 6 by a transport device 24 in the opposite direction as compared to the transport direction of the sheet 7 when the sheet 7 is conveyed through the DFI preheating step 6. Such an arrangement achieves the higher relative velocity without requiring the sheets 7 to be more sparsely arranged on the path 1, which is why there is no longer a demand for a separate conveyor path 14. In this case, it is preferred that the whole DFI device 100 is movable, so that the positioning of the DFI burner 102 as compared to the channel 104 is constant during the movement.

A movable DFI burner 12, 22 can also be combined with an additional path 14 with greater velocity, depending on the specific prerequisites and goals. It is also realized that, depending on cost considerations, the geometry of the details of sheet steel and so on, individual DFI burners may be used rather than burner ramps. However, it is preferred to use burner ramps operated as described below.

Moreover, in the embodiment shown in FIG. 4 it is preferred that the DFI burner 22 is moved both back and forth relative to the sheet 7 in the DFI preheating step 6, by aid of the transport device 24, such that the flame 23 of the DFI burner 22 is swept across the surface of the sheet 7 at least twice with a relative velocity which all the time is higher than the path velocity, either in the direction A or in the opposite direction. This makes it possible to achieve a high, even temperature in the DFI preheating step 6, without risking over-heating of the metal surface.

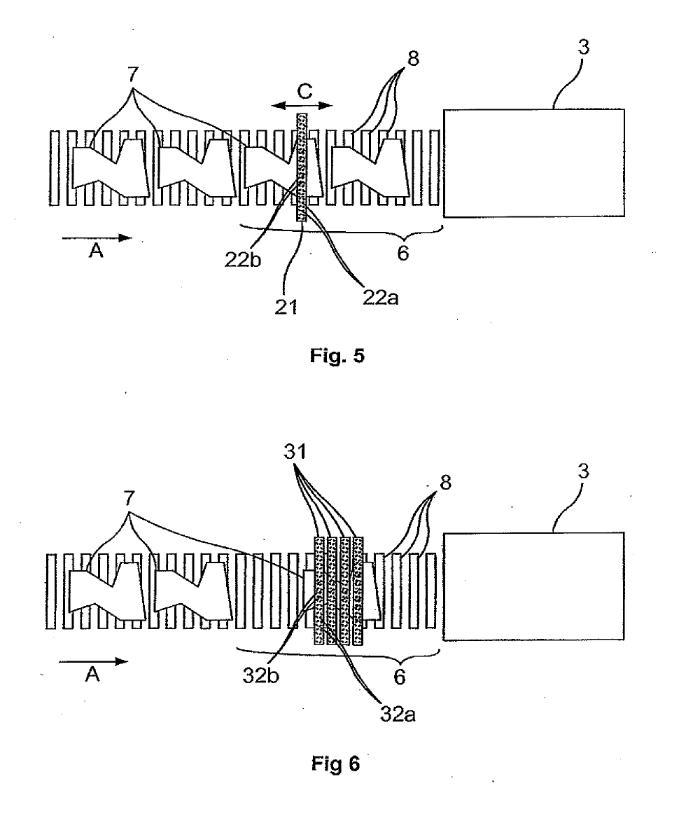

Instead of using a separate DFI burner, it is preferred to arrange one or a plurality of ramps 21, 31, which ramps are conventional per se, with DFI burners 22a, 22b, 32a, 32b, as is shown in FIGS. 5 and 6. The ramps 21, 31 are arranged at an angle, in FIGS. 5 and 6 90°, as compared to the direction A of transportation of the sheet 7. FIG. 5 illustrates the embodiment of FIG. 4, but from above. FIG. 6 illustrates an embodiment similar to that of FIG. 3, with movable burners, but unlike FIG. 3 having several parallel burner ramps 31, see below.

The flame of the burner ramps 21, 31 is thus swept across the surface of the steel sheet 7 at a relative velocity which is greater than the above discussed path velocity.

Furthermore, the use of such burner ramps 21, 31 makes it possible for the effective width perpendicularly to the direction A of transportation of the sheet 7 for the flame of the DFI burner ramp to be adjusted, whereby the flame does not impinge against the side edges of the sheet 7, so that overheating of these edges is avoided.

In the case with a burner ramp comprising several discrete DFI burners, such adjustment preferably takes place by switching off one or several DFI burners at the ends of the ramp. In the case with a burner ramp comprising a continuous, elongated flame, such adjustment preferably takes place by decreasing the width of the continuous flame by moving the end point of the flame in each end of the ramp towards the respective opposite end. See the patent applications referred to for more detailed information regarding such adjustment of the width of the effective flame.

It is preferred that the effective width of the ramp is adjusted so that no part of a DFI flame impinges against the edges of the sheet 7. Preferably, the effective width of the ramp is adjusted so that a margin of at least 10 times the largest thickness of the sheet 7 prevails around the edges of the sheet 7, across which margin surface no flames impinge against the surface of the sheet 7. Such adjustment is illustrated in FIGS. 5 and 6, wherein the DFI burners 22b, 32b presently being active are marked with dashed filling lines, while the DFI burners 22a, 32a presently being inactive are marked with no dashed filling lines. If the sheet 7 has a very complicated geometry, for example comprising holes, it is realized that the burner ramp 21, 31 when so is desired may give rise to several separate, adjacent, elongated zones with active flames separated by one or several inactive flames. The control of the effective flame width takes place in the corresponding way for a ramp with only one, elongated flame.

It is preferred that the adjustment of the effective width is performed continuously, so that it follows the form of the sheet 7 when the latter is moved in relation to the ramp or to each ramp 21, 31.

According to a preferred embodiment, illustrated in FIG. 6, several DFI burner ramps 31 are arranged one after the other, preferably in the direction A of transportation, so that each sheet 7 is heated by at least two DFI burner ramps during its journey past the DFI preheating step 6. In this case, the effective width perpendicularly to the direction A of transport of the sheet 7 for the DFI burner ramps 31 is controlled continuously and individually, as described above, so that the flames or flame does at no time impinge directly against the side edges of the sheet 7 or against the margin area discussed above.

According to a preferred embodiment, each DFI burner 12, 22a, 22b, 32a, 32b is only switched on once it has passed such an end edge of the sheet 7, in the direction A of transportation, and is located some distance in over the sheet 7, which distance preferably corresponds to the above discussed margin towards the side edge of the sheet 7. It is also preferred that each DFI burner 12, 22a, 22b, 32a, 32b is again switched off a distance, again preferably corresponding to said margin, before the burner in question again reaches the opposite side edge of sheet 7, in the direction A of transportation.

In case one or several burner ramps 21, 31 are used, according to the above, the corresponding is true either for each separate burner 22a, 22b, 32a, 32b individually, or, for a less complicated solution, for all burners in an individual ramp.

The switching on and off of individual burners 22a, 22b, 32a, 32b or whole ramps 21, 31 may be accomplished with a control device which is conventional as such.

Hence, using a method according to the present invention, metal products in the form of continuous, elongated products such as strips or rods, alternatively discrete sheets, can be rapidly and cost-efficiently heated using one or several DFI burners.

In the specific case in which the metal products are aluminum coated steel sheets which are to be alloyed and thereafter press-cooled, it is furthermore possible to substantially shorten the total door-to-door time without lowering demands on quality, especially without risking deteriorating hydrogen penetration into the material. In this case, possible time gains have proven to be about 2 minutes, which is a substantial part of the total processing time.

Above, preferred embodiments have been described. However, it is apparent to the skilled person that many modifications may be made to the described embodiments without departing from the idea of the invention.

For example, the DFI flame may be swept across the surface of the sheet with a high relative velocity in the DFI preheating step in directions other than back and forth in the direction of transportation of the sheet.

Another example is that what has been described above in connection to FIG. 1, concerning from what side of the metal product the flame from the DFI burner is arranged to impinge towards the surface of the metal product, and from which opposite side the hot combustion products are arranged to impinge towards the surface of the metal product at the second heating location, in applicable cases is valid also for the embodiments described above in connection to FIGS. 2-6.

Thus, the invention shall not be limited to the described embodiments, but may be varied within the scope of the enclosed claims.

1-15. (canceled)

16. A method for heating a metal product, comprising:
transporting the metal product along a conveyor path;
heating a first surface of the metal product with a flame from at least one burner disposed at a first heating location at the conveyor path;
conveying combustion products from the first heating location through at least one channel isolated from the metal product to a second heating location arranged at the conveyor path; and
impinging the combustion products from the at least one channel onto a second surface of the metal product at the second heating location.

17. The method of claim 16, wherein the burner comprises a direct flame impingement burner and the heating to the first surface is at an upper side of the metal product.

18. The method of claim 16, wherein the second heating location is located upstream of the first heating location.

19. The method of claim 16, wherein the conveyor path is perforated and the channel is in communication with the conveyor path, and further comprising passing the flame through the conveyor path into the channel.

20. The method of claim 19, wherein the perforated conveyor path comprises a transport surface selected from the group consisting of a mesh belt and walking beams.

21. The method of claim 16, further comprising arranging said at least one channel to provide the combustion products past the metal product on at least one side of the metal product to another channel leading to the second heating location.

22. The method of claim 16, further comprising providing a portion of the combustion products at the first heating location along the conveyor path for directly contacting the metal product, and joining said portion with the combustion products from the at least one channel for contacting the metal product.

23. The method of claim 16, further comprising operating the burner with an oxidant having at least 85% by weight of oxygen.

24. The method of claim 16, further comprising arranging a ramp of a plurality of the burners at an angle with respect to a direction of travel of the metal product along the conveyor path, and providing a single, elongated flame from the plurality of burners for heating the first surface of the metal product.

25. The method of claim 16, wherein the metal product comprises an aluminum coated metal sheet, and further comprising heating the metal product at the first and second heating locations to a select temperature for alloying the aluminum coating with steel material of the metal sheet, and pressing the metal sheet into a select shape.

26. The method of claim 25, further comprising transporting the metal sheet at a velocity along the conveyor path past the first and second heating locations at a rate for preventing overheating of the first and second surfaces of the metal sheet.

27. The method of claim 25, further comprising providing additional heating without direct flame impingement heating to the metal sheet before the alloying.

28. The method of claim 25, wherein the alloying occurs in a hydrogen-free atmosphere.

29. An apparatus for heating a metal product, comprising:
a conveyor path;
a first heating location at the conveyor path having at least one burner arranged to emit a flame to the conveyor path for contacting a first surface of the metal product;
a second heating location at the conveyor path and remote from the first heating location; and
a channel having a first end in communication within the first heating location for receiving combustion products from the flame, and extending to a second end in communication with the second heating location for the combustion products to contact a second surface of the metal product.

30. The apparatus of claim 29, wherein the conveyor path comprises perforations therethrough and through which the flame can pass into the first end of the channel.

31. The apparatus of claim 29, further comprising a ramp having a plurality of the burners, wherein the ramp is arranged at an angle relative to a direction of travel of the metal product for providing a single, elongated flame for impinging upon the metal product.
